(19) United States
(12) Patent Application Publication
(10) Pub. No.: US 2008/0002586 A1
(43) Pub. Date: Jan. 3, 2008

(54) End-point based tamper resistant congestion management

(76) Inventors: Ravi Sahita, Beaverton, OR (US); Karanvir S. Grewal, Hillsboro, OR (US); Manoj K. Wadekar, San Jose, CA (US); Uday R. Savagaonkar, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/479,789

(22) Filed: Jun. 30, 2006

(51) Int. Cl. H04J 1/16

(52) U.S. Cl. 370/235; 370/252

(57) ABSTRACT

In an embodiment, a method is provided. The method of this embodiment provides monitoring on a system flow statistics to identify one or more non-compliant traffic flows on the system, each of the one or more non-compliant traffic flows having packets; assigning a tag to each of the one or more non-compliant traffic flows, each of the tags corresponding to one of at least one congestion management policy; and applying one of the tags to each of the packets associated with any of the non-compliant traffic flows.

### FIELD

Embodiments of this invention relate to end-point based tamper resistant congestion management.

### BACKGROUND

In a bandwidth constrained environment, software components on a platform can misbehave by exceeding their allocated bandwidth. This can result in upstream congestion and impose strain on various network infrastructure components. Software level congestion management may, for example, rely on certain applications and protocols backing off their bandwidth usage. Since this type of congestion control may not encompass all applications and protocols, some are likely to be left uncontrolled, which may not help alleviate the bandwidth problem. Furthermore, software level solutions are susceptible to circumvention by, for example, misbehaving software (e.g., network stacks), and tamper. Network based congestion management solutions also exist. However, they may typically be bound to application protocols which do not always adhere to management requests. Furthermore, in network based congestion management solutions, network nodes maintain information on the traffic patterns of various nodes in the network, which may have a negative impact on the overall cost of congestion management.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system according to an embodiment.

FIG. 2 illustrates a congestion management component according to an embodiment.

FIG. 3 illustrates a network according to an embodiment.

FIG. 4 is a flowchart illustrating a method according to an embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

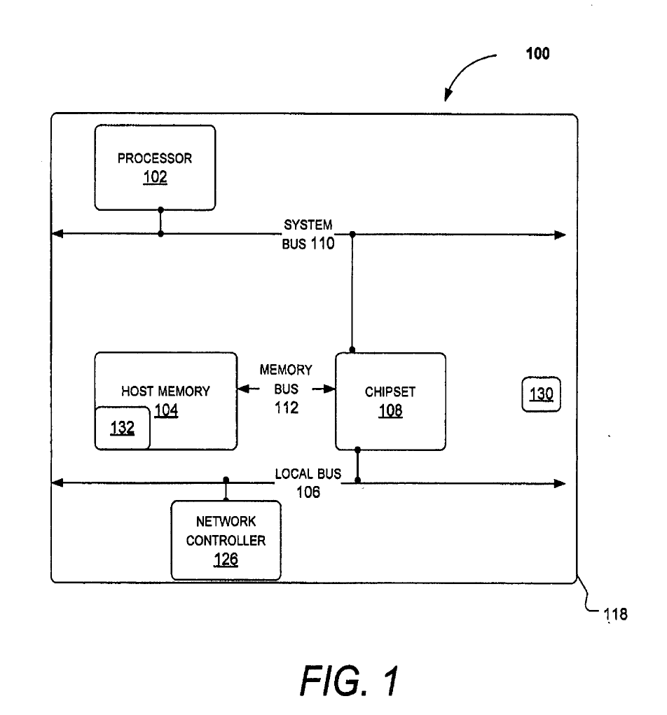

Methods described herein may be implemented in a system, such as system 100 illustrated in FIG. 1. System 100 may comprise one or more processors 102 (only one shown). A “processor” as discussed herein relates to a combination of hardware and software resources for accomplishing computational tasks. For example, a processor may comprise a system memory and processing circuitry (e.g., a central processing unit (CPU) or microcontroller) to execute machine-readable instructions for processing data according to a predefined instruction set. Alternatively, a processor may comprise just the processing circuitry (e.g., CPU). A processor may comprise a multi-core processor having a plurality of computational engines. Alternatively, a processor may comprise a computational engine that may be comprised in the multi-core processor, where an operating system may perceive the computational engine as a discrete processor with a full set of execution resources. Other possibilities exist.

System 100 may additionally comprise memory 104. Memory 104 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions 132 may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories.

Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. Chipset 108 may comprise a host bridge/hub system that may couple processor 102, and host memory 104 to each other and to local bus 106. Chipset 108 may communicate with memory 104 via memory bus 112 and with processor 102 via system bus 110. According to an embodiment, system 100 may comprise one or more chipsets 108 including, for example, an input/output control hub (ICH), and a memory control hub (MCH), although embodiments of the invention are not limited to this.

Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

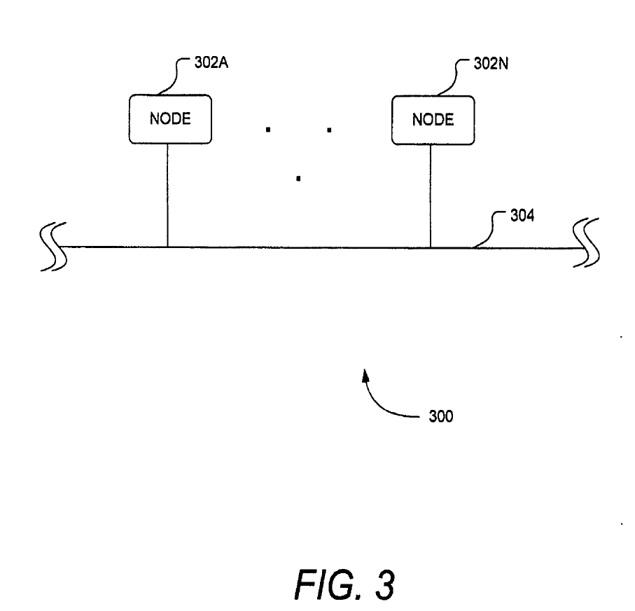

System 100 may additionally comprise one or more network controllers 126 (only one shown). A “network controller” as referred to herein relates to a device which may be coupled to a communication medium (such as communication medium 304 in FIG. 3, described below) to transmit data to and/or receive data from other devices coupled to the communication medium, i.e., to send and receive network traffic. For example, a network controller may transmit packets to and/or receive packets from devices coupled to a network such as a local area network. As used herein, a “packet” means a sequence of one or more symbols and/or values that may be encoded by one or more signals transmitted from at least one sender to at least one receiver. Such a network controller 126 may communicate with other devices according to any one of several data communication formats such as, for example, communication formats according to versions of IEEE (Institute of Electrical and Electronics Engineers) Std. 802.3 (CSMA/CD Access Method, 2002 Edition); IEEE Std. 802.11 (LAN/MAN Wireless LANS, 1999 Edition), IEEE Std. 802.16 (2003 and 2004 Editions, LAN/MAN Broadband Wireless LANS), Universal Serial Bus, Firewire, asynchronous transfer mode (ATM), synchronous optical network (SONET) or synchronous digital hierarchy (SDH) standards.

In an embodiment, network controller 126 may be comprised on system motherboard 118. Rather than reside on motherboard 118, network controller 126 may be integrated onto chipset 108. Still alternatively, network controller 126 may be comprised in a circuit card (not shown, e.g., NIC or network interface card) that may be inserted into circuit card slot (not shown).

System 100 may comprise logic 130. Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASICs (Application-Specific Integrated Circuits). Logic 130 may be hardwired to perform the one or more operations. Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of system 100, including network controller 126, chipset 108, processor 102, and/or on motherboard 118, or other components described herein. Logic 130 may be used to perform various functions by various components as described herein.

System 100 may comprise more than one, and other types of memories, buses, processors, and network controllers. Processor 102, memory 104, and busses 106,110, 112 may be comprised in a single circuit board, such as, for example, a system motherboard 118, but embodiments of the invention are not limited in this respect.

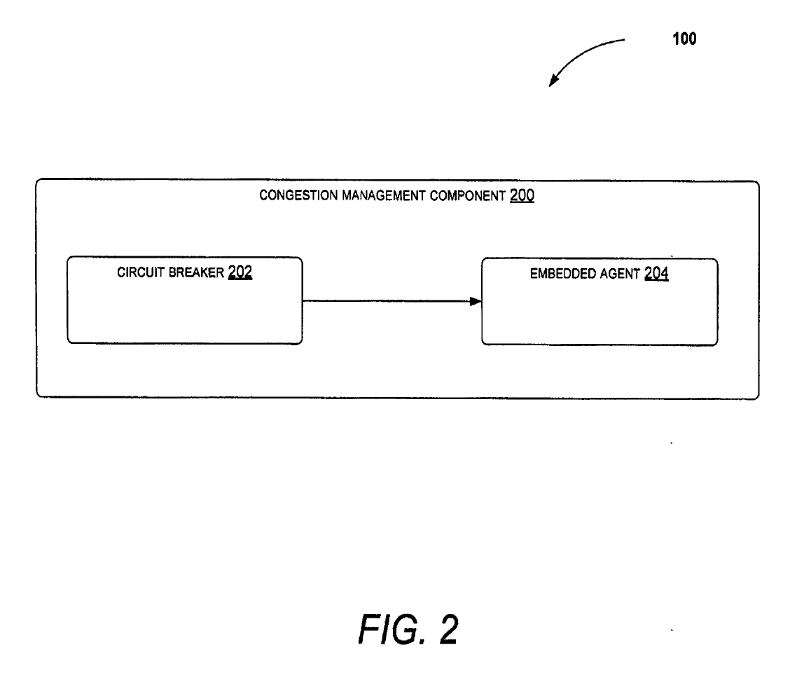

As illustrated in FIG. 2, system 100 may additionally comprise congestion management component 200. As used herein “congestion management component” refers to a component on system 100 that may be isolated from the main operating system so that it can operate in an out-of-band manner, and that is operable to receive congestion management policies from trusted sources, and to enforce those congestion management policies. Out-of-band refers to a mode of operation that is independent of the state of the operating system (e.g., running, in a reduced power state, or disabled due to system crash) or system power. In-band refers to a mode of operation in which the operating system is relied on.

In an embodiment, congestion management component 200 may comprise embedded agent 204 and circuit breaker 202. Embedded agent 204 may comprise, for example, a microcontroller or a microprocessor. In an embodiment, embedded agent 204 may enable manageability functions to be performed on a system, such as system 100. Manageability functions may comprise, for example, software updates/upgrades, running system diagnostics, and asset management. In an embodiment, embedded agent 204 may enable out-of-band manageability of system 100. In an embodiment, embedded agent may comprise a low bandwidth dedicated link to circuit breaker 202. Circuit breaker 202 may comprise hardware filters to scan incoming packets for known viruses and worms, and may isolate system 100 from network. In an embodiment, circuit breaker 202 may be programmed and/or configured to also filter out one or more packets associated with non-compliant flows (discussed below). In an embodiment, embedded agent 204 and circuit breaker 202 may enable system 100 to conform with Intel® Active Management Technology (IAMT), available from Intel® Corporation. Congestion management component 200 may be comprised on chipset 108 or on network controller 126. Alternatively, for example, congestion management component 200 functionality may be split: circuit breaker 202 may be comprised on network controller 126, and embedded agent 204 may reside on chipset 108. Other possibilities exist.

FIG. 3 illustrates a network 300 in which embodiments of the invention may operate. Network 300 may comprise a plurality of nodes 302A, . . . 302N, where each of nodes 302A, . . . , 302N may be communicatively coupled together via a communication medium 304. Nodes 302A . . . 302N may transmit and receive sets of one or more signals via medium 304 that may encode one or more packets. Communication medium 304 may comprise, for example, one or more optical and/or electrical cables, although many alternatives are possible. For example, communication medium 304 may comprise air and/or vacuum, through which nodes 302A . . . 302N may wirelessly transmit and/or receive sets of one or more signals.

In network 300, one or more of the nodes 302A . . . 302N may comprise one or more intermediate stations, such as, for example, one or more hubs, switches, and/or routers; additionally or alternatively, one or more of the nodes 302A . . . 302N may comprise one or more end stations. Also additionally or alternatively, network 300 may comprise one or more not shown intermediate stations, and medium 304 may communicatively couple together at least some of the nodes 302A . . . 302N and one or more of these intermediate stations. Of course, many alternatives are possible.

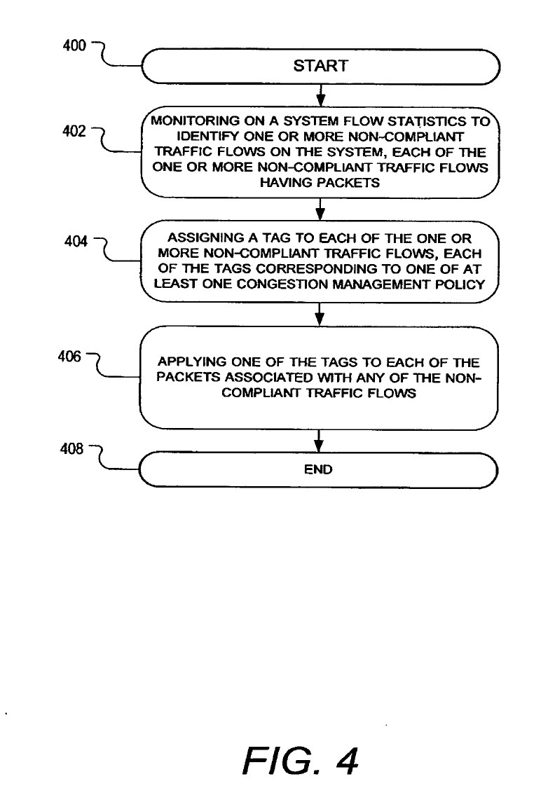

FIG. 4 is a flowchart illustrating a method according to an embodiment. The method may begin at block 400 and continue to block 402 where the method may comprise monitoring on a system flow statistics to identify one or more non-compliant traffic flows on the system, each of the one or more non-compliant traffic flows having packets.

In an embodiment, congestion management component 200 may receive congestion management policies (hereinafter “policies”) from any number of trusted sources. A trusted source refers to a source with which system 100 has established a trusted relationship. Trusted sources may be specifically identified, or may be inferred by administratively defined credentials. Trusted sources may comprise components within system 100, other nodes 302A, . . . 302N on network 300, including switches, routers, other congestion management/flow control systems, intrusion detection systems, and firewalls, for example.

Trusted sources may provide policies to congestion management component 200 in an in-band or out-of-band manner. A “policy” refers to a recommended or mandatory guide with which a flow is to comply. A policy may indicate, for example, specific rates for certain flows (e.g., 10 Mbps for video streaming flows), dynamic conditions (e.g., 10 Mbps from 9 AM to 10 AM PST Monday through Friday), or other criteria (e.g., a virtual machine running video streaming is given greater bandwidth than another virtual machine.

Congestion management component 200 may monitor flow statistics to determine if any of the flows on system 100 are non-compliant with the policies. A “flow” refers to a logical and/or physical connection between two endpoints via which packets may be communicated. A flow may have different levels of granularity. For example, a flow may refer to a connection between a specific source and destination address, or between specific ports associated with the source and destination address. Monitoring flow statistics may be done by examining header fields to statistically track flows for statistics, such as bandwidth usage. For example, by examining header information, such as port addresses, MPEG (Moving Picture Experts Group) streaming on a certain port may be monitored. Another way may be to obtain this information from other nodes, such as management stations. In an embodiment, circuit breaker 202 may have one hardware filter to track each flow, although embodiments of the invention are in no way limited in this respect.

In an embodiment, a hash table of flows may be maintained to identify one or more non-compliant traffic flows on the system. For example, a hash function on a given flow identifier (e.g., source and destination address in packet header) may correspond to an entry in a table, and statistics about each flow may be maintained in the table. Of course, other implementations may be used, such as a flow table, and TCAM (ternary content addressable memory), for example.

At block 404, the method may comprise assigning a tag to each of the one or more non-compliant traffic flows, each of the tags corresponding to one of the at least one policies. A tag may be assigned to each policy to uniquely identify the policy, and then assigned to each non-compliant traffic flow to identify the non-compliant flow as one to which the corresponding policy is to be applied. In an embodiment, congestion management component 200 may perform the former task, while a driver or a host network stack (not shown) executed by processor 102 may perform the latter task, although embodiments of the invention are not limited in this respect. Tags may be standards based (e.g. VLAN), proprietary, or some other type of identifier. In an embodiment, a VLAN (virtual local area network) tag may be assigned to each flow, where system 100 can differentiate between VLAN tags assigned to non-compliant traffic flows and VLAN tags assigned to compliant traffic flows.

Tags may be assigned in a way that force certain traffic types and/or devices to be forced through a separate network segment. For example, if a virtual machine or certain traffic is misbehaving (i.e., consuming too much bandwidth), the device/traffic may be placed in a quarantine network segment by assigning the appropriate tag. Enforcement elements (i.e., elements that enforce these policies) may be programmed and/or configured to interpret the tags so that the appropriate traffic conditioning can be applied to tagged packets in accordance with the policy corresponding to the tags. Enforcement may be performed by system (e.g., congestion management component 200) or by a network node (e.g., 302A, . . . , 302N).

In a virtualized platform (i.e., a system that is partitioned in order to function and be perceived as multiple systems using the hardware and/or software resources of a single system), in addition to a VLAN tag, the tag may include other information such as a virtual machine (VM) tag to identify a specific virtual system, a service type (e.g., application) associated with the packet, and an instance of the application connection. For example, this information could be combined with an IPv6 (Internet Protocol, version 6) flow identifier and be used by hardware filters on circuit breaker 202 to monitor the bandwidth of the flow. This combination of tags may help ensure that one operating system in the virtualized platform will not starve other operating systems of bandwidth. In an embodiment, the additional tag information may be added on by a virtual machine monitor (VMM) that sits on top of the main operating system and enables multiple operating systems and/or application stacks to be loaded on top of the VMM.

At block 406 the method may comprise applying one of the tags to each of the packets associated with any of the non-compliant traffic flows. In an embodiment, system 100 (e.g., a driver on system) may be able to differentiate between tags assigned to non-compliant traffic flows and tags assigned to compliant traffic flows. A driver, for example, may apply appropriate tags to those packets for the appropriate policy.

The method may end at block 408.

The tags assigned to the one or more non-compliant traffic flows may also be validated. For example, as packets are received, their tags may be checked to determine if the packets are compliant with the policy corresponding to their flow. Policies may be enforced using the tags. For example, if tagged packets are still not in compliance with the policy for their corresponding flow, then the one or more packets may be dropped. Flows that are non-compliant with their assigned policies may also be checked to determine if the flow has been in violation for an amount of time longer than a predetermined time. The predetermined time may be, for example, an amount of time it should take for a driver to respond to messages indicating that a flow is non-compliant.

If the time has not been exceeded, then a message may be prepared for the driver indicating which flow(s) are non-compliant. If the time has been exceeded, then driver may not be responding to messages to control bandwidth, and hardware filters may need to be modified to rate limit the non-compliant flow(s). If there are not enough hardware filters, then the filters may need to be modified to, for example, filter at a coarser level of granularity.

### CONCLUSION

Therefore, in an embodiment, a method may comprise monitoring on a system flow statistics to identify one or more non-compliant traffic flows on the system, each of the one or more non-compliant traffic flows having packets; assigning a tag to each of the one or more non-compliant traffic flows, each of the tags corresponding to one of at least one congestion management policy; and applying one of the tags to each of the packets associated with any of the non-compliant traffic flows.

Embodiments of the invention provide an end-point based solution to congestion management control that is an software level and network-based management solutions. The former solution may be limiting where its reliance on the back-off of applications and protocols may not encompass all applications and protocols, and may be vulnerable to circumvention by misbehaving software and tamper. The latter solution may place large strains on the network since, for example, network nodes need to maintain information on the traffic patterns of various nodes in the network. Embodiments of the invention transfer congestion management to specific network nodes in a network that are affected by particular flows, and enables the network nodes to manage, and in some embodiments, enforce the congestion management policies in a tamper-resistant manner. This may be particularly effective, for example, in ensuring enforcement of misbehaving applications. Furthermore, the implementation may be operating system independent so that it may be leveraged across different platforms.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
monitoring on a system flow statistics to identify one or more non-compliant traffic flows on the system, each of the one or more non-compliant traffic flows having packets;
assigning a tag to each of the one or more non-compliant traffic flows, each of the tags corresponding to one of at least one congestion management policy; and
applying one of the tags to each of the packets associated with any of the non-compliant traffic flows.

2. The method of claim 1, additionally comprising validating each of the tags assigned to the one or more non-compliant traffic flows by checking the tags assigned to incoming packets of the packets to determine if the packets are compliant with a policy corresponding to its flow.

3. The method of claim 2, additionally comprising dropping one or more packets if the one or more packets are not compliant with a policy corresponding to its flow.

4. The method of claim 1, additionally comprising determining if a non-compliant flow has been non-compliant for an amount of time longer than a predetermined time.

5. The method of claim 4, wherein if the predetermined time has not been exceeded, preparing a message to indicate the one or more non-compliant flows.

6. The method of claim 4, wherein If the predetermined time has been exceeded, then modifying one or more hardware filters to rate limit the one or more non-compliant flows.

7. The method of claim 1, wherein said monitor flow statistics on the system to identify one or more non-compliant traffic flows on the system comprises examining header fields to statistically track flows for bandwidth usage.

8. An apparatus comprising:
a congestion management component to:
receive congestion management policies on a system;
monitor flow statistics on the system to identify one or more non-compliant traffic flows on the system, each of the one or more non-compliant traffic flows having packets; and
assign a tag to each of the one or more non-compliant traffic flows, each of the tags corresponding to one of at least one congestion management policy.

9. The apparatus of claim 8, additionally comprising validating each of the tags assigned to the one or more non-compliant traffic flows by checking the tags assigned to incoming packets of the packets to determine if the packets are compliant with a policy corresponding to its flow.

10. The apparatus of claim 8, additionally forwarding the tags assigned to the one or more non-compliant flows to a driver on the system to enable the driver to apply the tags to the packets that correspond to the non-compliant flows.

11. The apparatus of claim 8, wherein said monitor flow statistics on the system to identify one or more non-compliant traffic flows on the system comprises examining header fields to statistically track flows for bandwidth usage.

12. A system comprising:
a circuit board; and
a network controller coupled to the circuit board, the network controller having a congestion management component to:
receive congestion management policies on a system;
monitor flow statistics on the system to identify one or more non-compliant traffic flows on the system, each of the one or more non-compliant traffic flows having packets; and
assign a tag to each of the one or more non-compliant traffic flows, each of the tags corresponding to one of at least one congestion management policy.

13. The system of claim 12, the congestion management component to additionally validate each of the tags assigned to the one or more non-compliant traffic flows by checking the tags assigned to incoming packets of the packets to determine if the packets are compliant with a policy corresponding to its flow.

14. The system of claim 12, the congestion management component to additionally forward the tags assigned to the one or more non-compliant flows to a driver on the system to enable the driver to apply the tags to the packets that correspond to the non-compliant flows.

15. The system of claim 12, wherein said monitor flow statistics on the system to identify one or more non-compliant traffic flows on the system comprises examining header fields to statistically track flows for bandwidth usage.

16. An article of manufacture having stored thereon instructions, the instructions when executed by a machine, result in the following:
monitoring on a system flow statistics to identify one or more non-compliant traffic flows on the system, each of the one or more non-compliant traffic flows having packets;
assigning a tag to each of the one or more non-compliant traffic flows, each of the tags corresponding to one of at least one congestion management policy; and
applying one of the tags to each of the packets associated with any of the non-compliant traffic flows.

17. The article of claim 16, additionally comprising instructions that result in validating each of the tags assigned to the one or more non-compliant traffic flows by checking the tags assigned to incoming packets of the packets to determine if the packets are compliant with a policy corresponding to its flow.

18. The article of claim 17, wherein said instructions that result in validating each of the tags assigned to the one or more non-compliant traffic flows by checking the tags assigned to incoming packets of the packets additionally comprises instructions that result in dropping one or more packets if the one or more packets are not compliant with a policy corresponding to its flow.

19. The article of claim 16, additionally comprising instructions that result in determining if a non-compliant flow has been non-compliant for an amount of time longer than a predetermined time.

20. The article of claim 16, wherein said instructions that result in monitoring flow statistics on the system to identify one or more non-compliant traffic flows on the system comprises instructions that result in examining header fields to statistically track flows for bandwidth usage.
